(19) United States
(12) Patent Application Publication
(10) Pub. No.: US 2026/0310390 A1
(43) Pub. Date: Oct. 8, 2026

(54) INFORMATION PROCESSING SYSTEM FOR REDUCING THE AMOUNT OF POWER CONSUMPTION, INFORMATION PROCESSING APPARATUS FOR REDUCING THE AMOUNT OF POWER CONSUMPTION, CONTROL METHOD FOR INFORMATION PROCESSING SYSTEM FOR REDUCING THE AMOUNT OF POWER CONSUMPTION, AND STORAGE MEDIUM FOR REDUCING THE AMOUNT OF POWER CONSUMPTION

(71) Applicant: CANON KABUSHIKI KAISHA, Tokyo (JP)

(72) Inventor: HIROTAKA FUNAYAMA, Kanagawa (JP)

(21) Appl. No.: 19/631,552

(22) Filed: Mar. 27, 2026

(30) Foreign Application Priority Data
Apr. 4, 2025 (JP) 2025-062549

(51) Int. Cl. G06F 3/12

(52) U.S. Cl. CPC G06F 3/1221; G06F 3/1254

(57) ABSTRACT

An information processing system comprising: one or more memory devices that store a set of instructions; and one or more processors that execute the set of instructions to obtain a first print setting of a predetermined image forming apparatus, obtain a power consumption indicating an amount of power consumed by all image forming apparatuses included in a group to which the predetermined image forming apparatus belongs, make a first determination about achievement of a power consumption reduction target for the group with use of the obtained power consumption, and generate, in accordance with a result of the first determination, a second print setting that enables a reduction in power consumption compared to a case where printing is performed using the first print setting.

### BACKGROUND

### Field of the Technology

The present disclosure relates to an information processing system, an information processing apparatus, a control method for an information processing system, and a storage medium.

### Description of the Related Art

With increased awareness of environmental problems, including efforts toward realization of a decarbonized society, efforts have been made to reduce the amount of power consumption (or the amount of carbon dioxide emissions converted from the amount of power consumption) of printers in organizational units such as companies and departments. For example, a target, such as an N % reduction in a calendar quarter compared to the same period of a previous year, is set in an organizational unit. In a case where an organization owns a plurality of printers, monitoring each printer makes it possible to judge, for example, whether a target can be achieved if the current usage status is kept, or whether there are strategies that can be taken to achieve a target.

It is described in Japanese Patent Laid-Open No. 2010-134765 that a target value for the number of printed sheets within a predetermined period is set for users so as to improve environmental awareness of the users. It is also described therein that whether a target has been achieved is displayed based on the actual performance values of printing by the users, and also that a selection of whether to execute printing is made when it has been determined that the target has not been achieved.

In the method described in Japanese Patent Laid-Open No. 2010-134765, a target value is set for users. Therefore, even when it is judged that a target can be achieved in an organizational unit based on the actual performance values of printing in the overall organization, if the number of sheets printed by a specific user is large, an ineffective display intended to suppress printing is output to this user. Conversely, for example, even in a state where a target cannot be achieved in organizational units, no restriction is imposed on a user who has performed little printing. Therefore, this user will be able to perform printing freely. This gives rise to the possibility that the amount of power consumption in the organizational unit will further increase. As described above, as power consumption varies among image forming apparatuses that belong to an organization, it is difficult to create effective strategies to make efforts toward a reduction in the amount of power consumption in an organizational unit.

### SUMMARY

The present disclosure enables realization of provision of a technique that can suppress creation of ineffective strategies to make efforts toward a reduction in the amount of power consumption of an image forming apparatus in an organizational unit.

One aspect of the present disclosure provides an information processing system comprising: one or more memory devices that store a set of instructions; and one or more processors that execute the set of instructions to obtain a first print setting of a predetermined image forming apparatus, obtain a power consumption indicating an amount of power consumed by all image forming apparatuses included in a group to which the predetermined image forming apparatus belongs, make a first determination about achievement of a power consumption reduction target for the group with use of the obtained power consumption, and generate, in accordance with a result of the first determination, a second print setting that enables a reduction in power consumption compared to a case where printing is performed using the first print setting.

Features of the present disclosure will become apparent from the following description of embodiments with reference to the attached drawings. The following description of embodiments is described by way of example.

### BRIEF DESCRIPTION OF THE DRAWINGS

The accompanying drawings, which are incorporated in and constitute a part of the specification, illustrate embodiments of the present disclosure, and together with the description, serve to explain the principles of the embodiments.

FIG. 1 is an outline diagram of a print system according to an embodiment.

FIGS. 2A and 2B are hardware configuration diagrams of the print system according to an embodiment.

FIG. 3 is a software configuration diagram of the print system according to an embodiment.

FIG. 4 is a diagram illustrating a display screen according to an embodiment.

FIG. 5 is a flowchart illustrating processing according to an embodiment.

FIG. 6 is a flowchart illustrating processing according to an embodiment.

FIG. 7 is a software configuration diagram according to an embodiment.

FIG. 8 is a flowchart illustrating processing according to an embodiment.

FIG. 9 is a flowchart illustrating processing according to an embodiment.

### DESCRIPTION OF THE EMBODIMENTS

Hereinafter, embodiments will be described in detail with reference to the attached drawings. Note, the following embodiments are not intended to limit the scope of the claims. Multiple features are described in the embodiments, but it is not the case that all such features are required, and multiple such features may be combined as appropriate. Furthermore, in the attached drawings, the same reference numerals may be given to the same or similar configurations, and redundant description thereof is omitted.

### First Embodiment

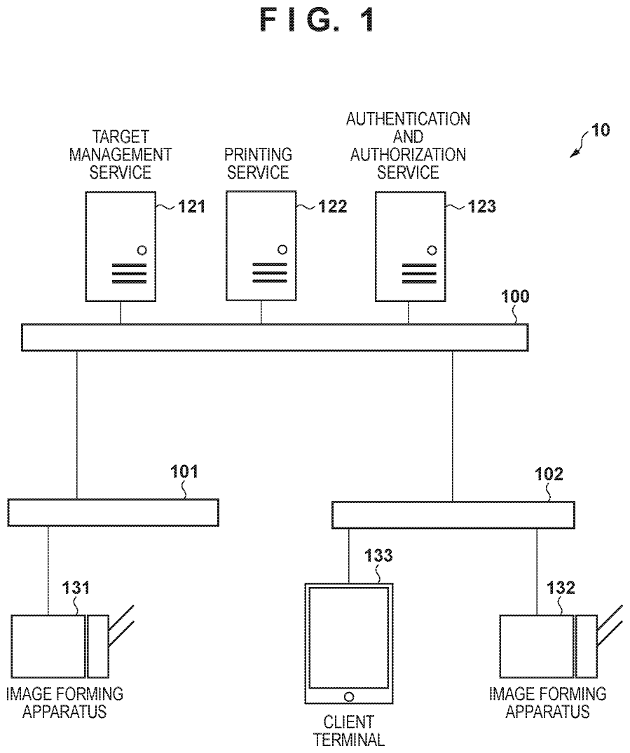

An outline of a configuration of a print system 10 according to a first embodiment will be described with reference to FIG. 1. The print system 10 (an example of an “information processing system”) is configured to include image forming apparatuses (131, 132), a client terminal 133 (an example of an “information processing terminal”), a target management service 121, a printing service 122, and an authentication and authorization service 123. These apparatuses are connected to one another via the Internet 100 and local networks (101, 102). Note that hereinafter, the Internet 100 or the local networks (101, 102) are also simply referred to as networks (100 to 102).

The image forming apparatuses (131, 132) have, for example, a printing function, a copy function, a scanner function, a facsimile transmission function, and so forth. The image forming apparatuses (131, 132) may be apparatuses of an electrophotographic method that transfer toner to paper and fix the toner thereon, may be inkjet printers that perform printing by ejecting ink onto paper, or may be apparatuses capable of performing three-dimensional printing. Also, the image forming apparatuses (131, 132) may not have, for example, at least one of the copy function, the scanner function, or the facsimile transmission function. Note that although FIG. 1 illustrates two image forming apparatuses, the number of image forming apparatuses may be one, or may be three or more.

The client terminal 133 is a data processing apparatus, such as a personal computer or a mobile terminal, intended for a user to use cloud services. With respect to the target management service 121, the user obtains and sets a reduction target for the amount of power consumption by operating a reduction target setting application 301 (described later) running on the client terminal 133. Also, the user transmits a print setting and print data to the printing service 122 by operating a print application 302 (described later) running on the client terminal 133.

The target management service 121 is, for example, a computer, and has a function of holding the actual performance (hereinafter also referred to as a job log) of a print job in the image forming apparatuses (131, 132). Also, the target management service 121 has a function of managing a target of the amount of power consumption of an organization, and a function of converting a print setting into a print setting that enables a further reduction in the amount of power consumption.

The printing service 122 is, for example, a computer, and executes processing for converting print data into a format that can be printed by the image forming apparatuses (131, 132) in response to an instruction from the client terminal 133. Also, the printing service 122 provides the converted print data to the image forming apparatuses (131, 132).

The authentication and authorization service 123 is, for example, a computer, and has a function of authenticating and authorizing the entire cloud services provided by such computers as the target management service 121 and the printing service 122, managing tenants, and so forth. The user who operates the client terminal 133 obtains an authentication token by accessing and performing a user login on the authentication and authorization service 123, and further obtains an authorization token by using the authentication token. The user who operates the client terminal 133 can access the target management service 121 and the printing service 122 by using the authorization token.

The networks (100 to 102) are, for example, so-called communication networks realized by a LAN or a WAN like the Internet, telephone lines, dedicated digital lines, ATM or frame relay lines, cable television lines, wireless lines for data broadcasting, and so forth. It is sufficient for the Internet 100 and the local networks (101, 102) to be capable of transmitting and receiving data.

The image forming apparatuses (131, 132) and the client terminal 133 can access the target management service 121 and the printing service 122 via the local networks (101, 102) and the Internet 100. Furthermore, the image forming apparatuses (131, 132) and the client terminal 133 can also access the target management service 121, the printing service 122, and the authentication and authorization service 123 by directly accessing the Internet 100.

Here, the target management service 121, the printing service 122, and the authentication and authorization service 123 may be, for example, a redundant cloud server composed of a plurality of servers. In this case, the cloud services are made public on the Internet as a result of cooperation among these cloud servers. Furthermore, the functions of the cloud services may be realized by a single server or a single virtual server, or may be realized by a plurality of servers or a plurality of virtual servers. Note that the plurality of virtual servers may be provided on a single server.

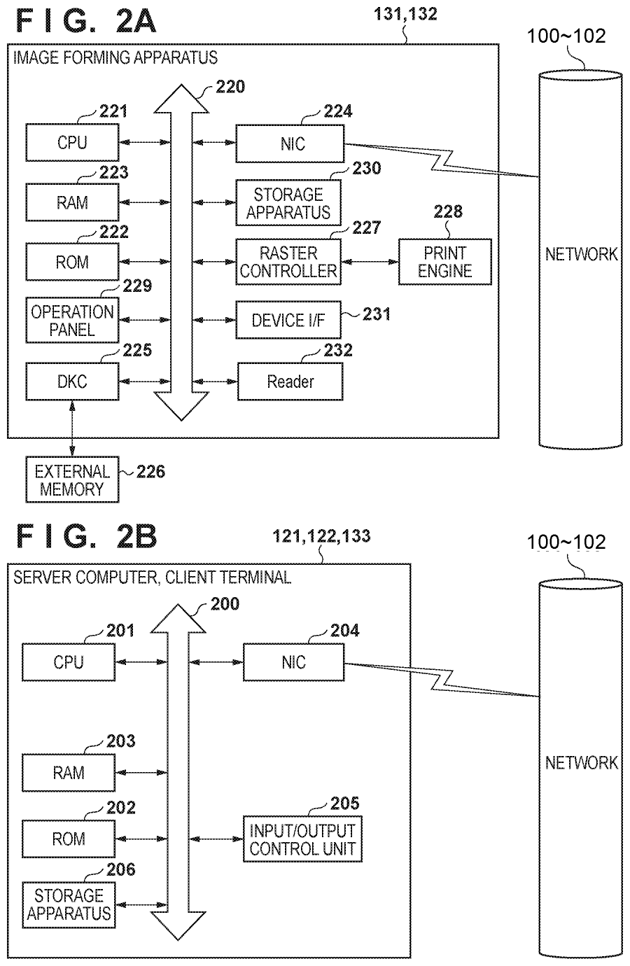

Next, a hardware configuration of each apparatus constituting the print system 10 will be described with reference to FIGS. 2A and 2B. FIG. 2A exemplarily shows a hardware configuration of the image forming apparatuses (131, 132). The image forming apparatuses (131, 132) are configured to include a CPU 221, a ROM 222, a RAM 223, a network interface card (NIC) 224, and a disk controller (DKC) 225. Also, the image forming apparatuses (131, 132) are configured to include a raster controller 227, a print engine 228, an operation panel 229, a storage apparatus 230, a device I/F 231, a reader 232, and a system bus 220 to which each of these constituents is connected.

The CPU 221 controls the entire apparatus, and integrally controls access to various types of devices connected to the system bus 220. Such control is executed based on control programs and the like stored in the ROM 222, or on control programs, resource data (resource information), or the like stored in an external memory 226 connected via the DKC 225.

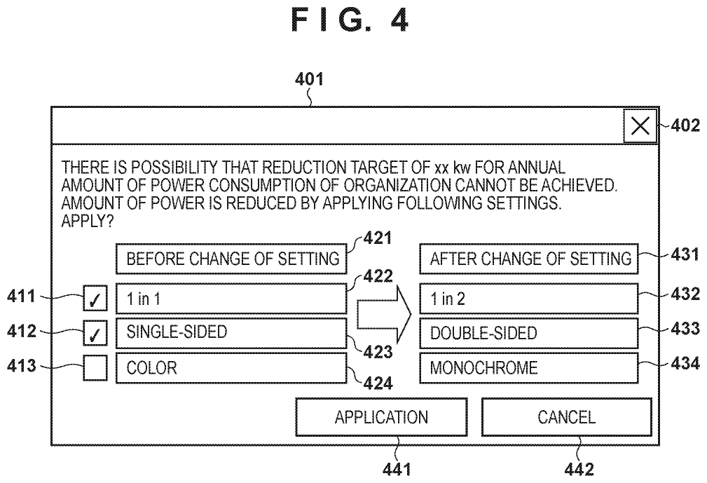

The RAM 223 functions as a main memory, a working area, and the like for the CPU 221. Also, the RAM 223 is configured to be capable of expanding the memory capacity with use of an optional RAM connected to a non-illustrated expansion port. The storage apparatus 230 is an external storage apparatus that functions as a large-capacity memory, and stores each of later-described programs. The operation panel 229 (also referred to as an operation unit) includes a display unit, such as a liquid crystal panel, displays screens, and accepts operational instructions of a user via the screens. Also, the operation panel 229 displays settings of operational modes and the like of the image forming apparatuses (131, 132), operational statuses of the image forming apparatuses (131, 132), buttons for performing an operation of, for example, designating a copy, and so forth. A reduction setting application screen, as illustrated in FIG. 4, which will be described later, is displayed for the user via the operation panel 229. Note that these buttons may be provided physically.

The NIC 224 is configured to include a communication module and performs transmission and reception of data between the image forming apparatuses (131, 132) and an external apparatus connected via the networks 100 to 102. The print engine 228 uses known printing techniques, and is, for example, an engine that uses an electrophotographic method (laser beam method), an inkjet method, a sublimation (thermal transfer) method, or the like.

The raster controller 227 is a controller that converts a format of print data, such as a page description language (PDL) and a portable document format (PDF), into a format for image data. The device I/F 231 is configured to include, for example, a connector that supports a USB and the like, and enables connection between the image forming apparatuses (131, 132) and an external device. The reader 232 is a scanner apparatus that reads a document. The image forming apparatuses (131, 132) realize the copy function by processing a read image via the print engine 228.

FIG. 2B exemplarily shows a hardware configuration of an information processing apparatus applicable to the client terminal 133, target management service 121, printing service 122, and authentication and authorization service 123. Note that this information processing apparatus may be replaced with a system configured to include a plurality of apparatuses, or may be replaced with a system connected via a network like a LAN or a WAN, as long as it can execute the functions described below.

The information processing apparatus is configured to include a CPU 201, a ROM 202, a RAM 203, an NIC 204, an input/output control unit 205, a storage apparatus 206, and a system bus 200 to which each of these constituents is connected. The CPU 201 controls each constituent of this information processing apparatus, and executes application programs and an operating system by loading the application programs and the operating system from the storage apparatus 206. The application programs include programs of various types of applications installed in the target management service 121, printing service 122, authentication and authorization service 123, and client terminal 133. Also, the CPU 201 performs control to temporarily store information, files, and the like that are necessary for the execution of programs into the RAM 203.

Such programs as a basic I/O program and various types of data are stored inside the ROM 202. The RAM 203 temporarily stores data, and functions as a main memory, a working area, and the like for the CPU 201. The NIC 204 is configured to include a communication module and performs transmission and reception of data between the information processing apparatus and an external apparatus connected via the networks 100 to 102.

The input/output control unit 205 controls transmission and reception of data between the information processing apparatus and external apparatuses. The external apparatuses connected to the input/output control unit 205 include, for example, an apparatus that displays information for a user, such as a display and a liquid crystal panel, and an apparatus that accepts a user input, such as a mouse, a keyboard, and a touch panel. Note that these external apparatuses may be configured integrally with the information processing apparatus. In this case, the input/output control unit 205 controls inputs/outputs that are made to/from the constituents configured integrally with the information processing apparatus. The storage apparatus 206 is a storage apparatus that functions as a large-capacity memory, and stores application programs, an OS, and the like.

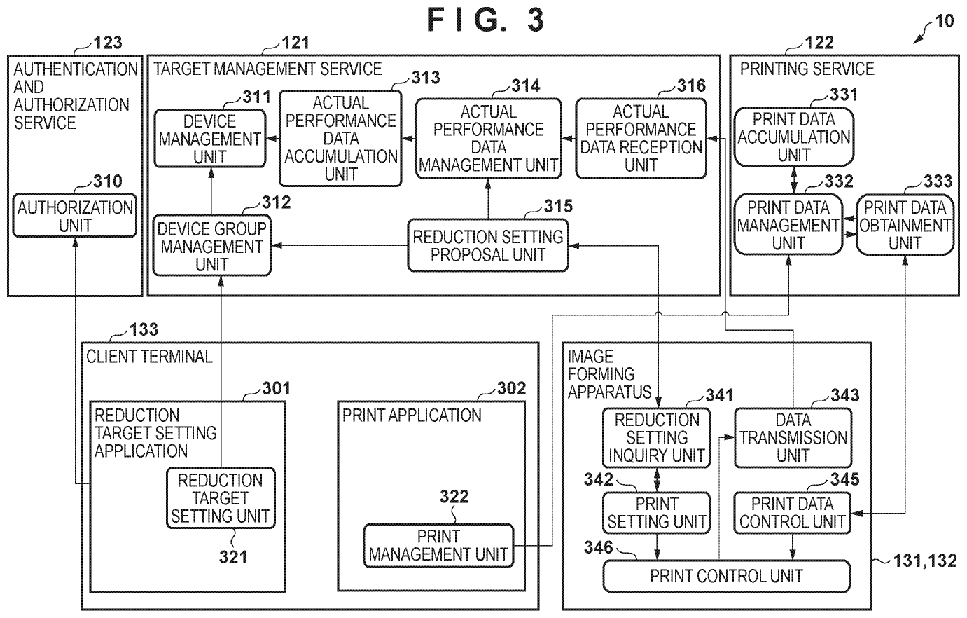

Next, a software configuration of each apparatus constituting the print system 10 will be described with reference to FIGS. 3 and 4. FIG. 3 exemplarily shows software configurations of the target management service 121, printing service 122, authentication and authorization service 123, client terminal 133, and image forming apparatuses (131, 132). Note that each of the software modules of the target management service 121, printing service 122, authentication and authorization service 123, and client terminal 133 is stored in the storage apparatus 206 shown in FIG. 2B, and loaded into the RAM 203 and executed by the CPU 201. Similarly, each of the software modules of the image forming apparatuses (131, 132) is stored in the storage apparatus 230 shown in FIG. 2A, and loaded into the RAM 223 and executed by the CPU 221.

The authentication and authorization service 123 includes an authorization unit 310. The authorization unit 310 receives an authentication token that is issued at the time of user login, performs scope validation, and then issues an authorization token.

The target management service 121 includes a device management unit 311, a device group management unit 312, an actual performance data accumulation unit 313, an actual performance data management unit 314, a reduction setting proposal unit 315, and an actual performance data reception unit 316. The actual performance data reception unit 316 receives job logs from the image forming apparatuses (131, 132). The actual performance data management unit 314 (an example of a “power management unit”) saves the job logs that the actual performance data reception unit 316 has received from the image forming apparatuses (131, 132) into the actual performance data accumulation unit 313. Table 1 exemplarily shows job logs accumulated in the actual performance data accumulation unit 313.

TABLE 1
Job Log Information

| | | | | Double/ | N-in-1 | No. of | Power |
|---|---|---|---|---|---|---|---|
| Time (UTC) | Serial No. | Color | Size | Single | Printing | Pages | Consumption |
| 2023 Nov. 20 | AAA00000 | Color | A3 | Double | 1-in-1 | 10 | 0.41 kWh |
| 19:20 | | | | | | | |
| 2023 Nov. 20 | BBB00001 | Mono- | A4 | Double | 4-in-1 | 5 | 0.22 kWh |
| 19:20 | | chrome | | | | | |
| 2023 Nov. 20 | BBB00002 | Color | A4 | Single | 4-in-1 | 8 | 0.38 kWh |
| 19:20 | | | | | | | |

In Table 1, the Time (UTC) column indicates the time at which printing was executed. The Serial No. column indicates identifiers of the image forming apparatuses (131, 132) that executed printing. Each of the Color, Size, Double/Single, and N-in-1 Printing columns indicates a print setting of a print job that was printed by the image forming apparatus (131, 132) indicated by the Serial No. column at the time indicated by the time column.

More specifically, the Color column indicates whether the print setting is color printing or monochrome printing. The Size column indicates a setting of a sheet size at the time of printing. The Double/Single column indicates whether the print setting is double-sided printing or single-sided printing. The N-in-1 Printing column indicates a setting of N-in-1 printing (N-up printing). The No. of Pages column indicates the number of pages to be printed. The Power Consumption column indicates the result of calculation of power that is consumed as a result of the image forming apparatus 131 or the image forming apparatus 132 performing printing under the indicated corresponding color, size, double/single, and N-in-1 printing print settings.

Note that data that is received by the actual performance data reception unit 316 and accumulated in the actual performance data accumulation unit 313 may include data of the image forming apparatuses (131, 132) other than a job log, such as configuration information and error information.

The device management unit 311 manages the image forming apparatuses (131, 132) as device information. Table 2 shows device information managed by the device management unit 311.

TABLE 2
Device Information

| Tenant | | Place of | Last |
|---|---|---|---|
| ID | Serial No. | Installation | Communication Time |
| A | AAA00000 | Laboratory 1 | 2023 Dec. 1 |
| A | BBB00001 | Laboratory 1 | 2023 Dec. 2 |
| A | BBB00002 | Laboratory 2 | 2023 Dec. 2 |
| B | CCC12345 | Conference Room 1 | 2023 Dec. 2 |
| C | XXX22222 | XX Building, 2^{nd} Floor | 2023 Nov. 20 |

In Table 2, the Serial No. column indicates identifiers that uniquely identify the image forming apparatuses (131, 132). The Tenant ID column indicates identifiers that represent organizations to which the image forming apparatuses (131, 132) indicated by the Serial No. column belong. The Place of Installation column indicates places of installation of the image forming apparatuses (131, 132) indicated by the Serial No. column. Note that association between the Serial No. column and the Tenant ID column, inputting of the places of installation, and the like are made through a task of registration of the image forming apparatuses (131, 132).

The Last Communication Time column indicates the time of last transmission of data from the image forming apparatuses (131, 132) to the actual performance data reception unit 316. The device management unit 311 updates the Last Communication Time column by receiving, from the actual performance data accumulation unit 313, an event indicating that data of the image forming apparatuses (131, 132) corresponding to the Serial No. column has been stored in the actual performance data accumulation unit 313.

The device group management unit 312 groups the image forming apparatuses (131, 132) that are within the same organization, that is to say, that have the same tenant ID. Note that groups that have been formed in this manner are hereinafter also referred to as device groups. Then, the device group management unit 312 (an example of a “group information management unit”) manages the reduction targets of the amount of power consumption of the device groups. Table 3 exemplarily shows device group information managed by the device group management unit 312.

TABLE 3
Device Group Information

| | | Tenant | Reduction Target |
|---|---|---|---|
| Group ID | Serial No. | ID | (Compared to Previous Year) |
| Group 1 | AAA00000, | A | −5% |
| | BBB00001, | | |
| | BBB00002 | | |
| Group 2 | CCC12345, | B | −3% |
| | CCC12346 | | |
| Group 3 | XXX22222 | C | −1% |

The Group ID column indicates identifiers of the device groups. The Serial No. column indicates identifiers of the image forming apparatuses (131, 132) that belong to the device groups identified by the Group ID column. The numbers that can be set in the Serial No. column are identifiers of the image forming apparatuses (131, 132) included in the device information managed by the device management unit 311. Furthermore, the numbers that can be set in the Serial No. column are, among these identifiers, identifiers of the image forming apparatuses (131, 132) that are included in a tenant to which a user himself/herself belongs among the tenants described in the Tenant ID column. The Tenant ID column indicates tenant IDs of tenants that own the device groups. Note that the Serial No. column and the Reduction Target column are set by the user operating the reduction target setting application 301 (described later) running on the client terminal 133.

In response to a request from a reduction setting inquiry unit 341 of the image forming apparatuses (131, 132), the reduction setting proposal unit 315 proposes a print setting intended to achieve the reduction target for each device group managed by the device group management unit 312. That is to say, the reduction setting proposal unit 315 receives the current print setting from the reduction setting inquiry unit 341. Then, the reduction setting proposal unit 315 proposes a print setting with use of the reduction target and actual performance data of the device group to which the image forming apparatuses (131, 132) belong. Note that the reduction target of the device group has been obtained from the device group management unit 312. Also, the actual performance data has been obtained from the actual performance data accumulation unit 313 via the actual performance data management unit 314. The print setting proposed by the reduction setting proposal unit 315 is, for example, “double-sided/monochrome” in a case where the current print setting is “single-sided/color.” In this way, the reduction setting proposal unit 315 proposes a print setting that can further reduce the amount of power consumed.

The client terminal 133 includes the reduction target setting application 301 and the print application 302. Furthermore, the reduction target setting application 301 includes a reduction target setting unit 321. The reduction target setting unit 321 registers the device group information shown in Table 3 by accessing the device group management unit 312 of the target management service 121. Also, the print application 302 includes a print management unit 322. The print management unit 322 displays image data and a document in a state where they are held in the client terminal 133. Then, the print management unit 322 accepts and sets a print setting, and transmits a print job to a print data management unit 332 of the printing service 122.

The printing service 122 includes a print data accumulation unit 331, a print data management unit 332, and a print data obtainment unit 333. The print data management unit 332 receives a print job from the print management unit 322 of the client terminal 133. Then, the print data management unit 332 registers the received print job with the print data accumulation unit 331. The print data accumulation unit 331 saves this print job in the storage apparatus 206. The following Table 4 exemplarily shows management information of print jobs managed by the print data accumulation unit 331.

TABLE 4
Print Job Management Information

| Job ID | User ID | Print Data |
|---|---|---|
| job01 | user01 | YXVpdGdhd2VpZ2FId2dhZTBpdGFqd2VyamF3b2VuZm |
| | | F103dmaGFpb3dIcmphdy1dZXJhd2U6cjBAYWVyYXc= |
| job02 | user01 | ZGFwc3VI0GZh0XB3dWU40TByYXV3ZThyYTM0a2py |
| | | bmF3aW91cmph03dIcmphd2IvZWpyb2F3ZXJh |
| job03 | user02 | a2Fkd3NqaGZ1029pYWpmd2Vyd2EuYXdIcmhhd2Vybnd |
| | | ha2VyYS53YXdka2xmbmhha2p3ZWYsYXdlZg== |

In Table 4, the Job ID column indicates IDs which were generated when the print data management unit 332 registered print jobs with the print data accumulation unit 331, and which uniquely identify the print jobs. The User ID column indicates identifiers of users who input the print jobs by operating the client terminal 133. The print data column indicates binary data representing contents and print settings. The print data obtainment unit 333 accepts a print job obtainment request from the image forming apparatuses (131, 132), and transmits a print job in a state where it has been stored in the print data accumulation unit 331 to the image forming apparatuses (131, 132) via the print data management unit 332.

Next, software blocks of the image forming apparatuses (131, 132) will be described. The image forming apparatuses (131, 132) include a reduction setting inquiry unit 341, a print setting unit 342, a data transmission unit 343, a print data control unit 345, and a print control unit 346. The print data control unit 345 obtains a list of print jobs of a user who has logged into the image forming apparatuses (131, 132) from the print data obtainment unit 333 of the printing service 122, and passes the obtained print jobs to the print control unit 346. The print control unit 346 displays the list of print jobs passed from the print data control unit 345 on the operation panel 229. The user selects a job to be printed from the list of print jobs displayed on the operation panel 229. Accordingly, the print control unit 346 executes printing by passing the corresponding print job to the raster controller 227.

A method of realizing forced hold printing in the image forming apparatuses (131, 132) will now be described. That is to say, a print job input from the print application 302 of the client terminal 133 is held in the printing service 122 for the time being. Thereafter, at least one of the image forming apparatuses (131, 132) makes a request for obtainment of a print job of a predetermined user to the printing service 122. Accordingly, the printing service 122 returns this print job to the image forming apparatuses (131, 132). Then, the image forming apparatuses (131, 132) execute printing in accordance with this print job. In this way, forced hold printing is realized. Note that a detailed method of realizing forced hold printing will be described in a second embodiment.

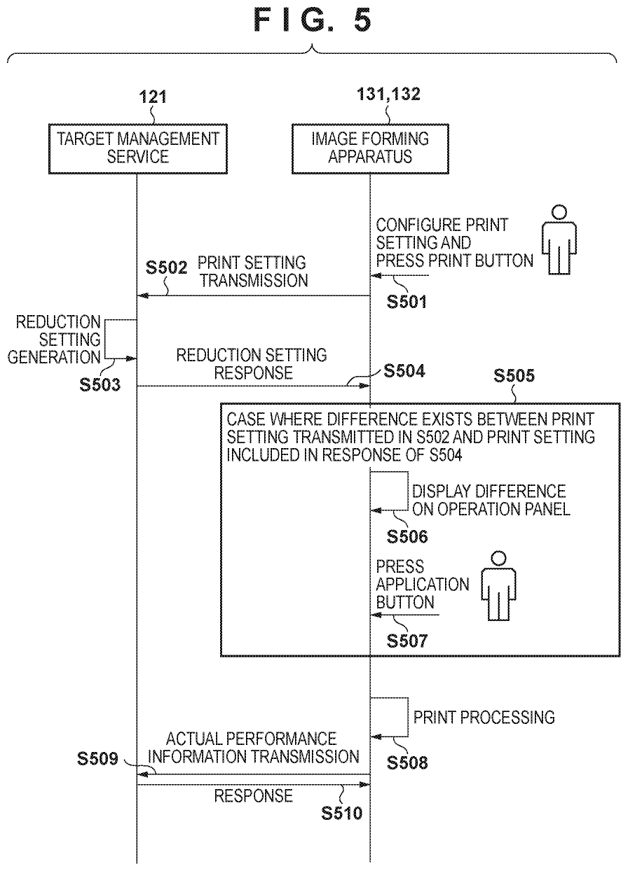

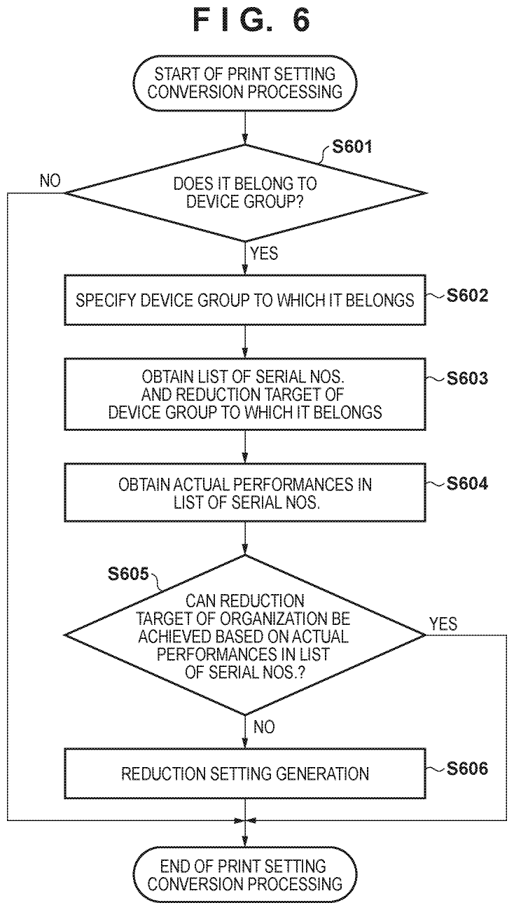

Next, a method of printing (copying) a document that has been read via the reader 232 of the image forming apparatus (131, 132) will be described with reference to FIG. 4 to FIG. 6. Note that the processing illustrated in FIG. 5 and FIG. 6 is realized by the CPU of each apparatus constituting the print system 10 deploying programs stored in the ROM of each apparatus to the RAM and executing the programs.

In step S501 of FIG. 5, a user configures a print setting, such as monochrome/color, an N-in-1 setting, and single/double, via the print setting unit 342 by operating the operation panel 229 of the image forming apparatus (131, 132). Then, once the user has set an original document on the reader 232, he/she presses a print button on the image forming apparatus (131, 132). The print setting unit 342 (an example of an “acceptance unit”) of the image forming apparatus (131, 132) accepts the user's pressing operation on the print button, and starts print processing upon detection of this pressing operation.

In step S502, the print setting unit 342 transmits, to the reduction setting inquiry unit 341, the serial No. of the image forming apparatus (131, 132) on which the print button has been pressed, and the print setting configured by the user. The reduction setting inquiry unit 341 further transmits, to the reduction setting proposal unit 315 of the target management service 121, the serial No. of the image forming apparatus (131, 132) and the print setting (an example of a “first print setting”) that have been received from the print setting unit 342. Note that the reduction setting inquiry unit 341 is an example of a “second output unit.” Then, the reduction setting proposal unit 315 receives the serial No. of the image forming apparatus (131, 132) and the print setting. In step S503, the reduction setting proposal unit 315 generates a reduction setting with use of the serial No. of the image forming apparatus (131, 132) and the print setting that have been received.

FIG. 6 exemplarily shows a detailed flowchart of the processing of step S503. In step S601, the reduction setting proposal unit 315 determines whether the image forming apparatus (131, 132) for which the print setting has been executed belongs to a device group via the device group management unit 312. That is to say, the reduction setting proposal unit 315 determines whether there is a device group that includes the serial No. of the image forming apparatus (131, 132) with use of, for example, Table 3. Then, when the reduction setting proposal unit 315 has determined that the image forming apparatus (131, 132) for which the print setting has been executed belongs to a device group, the processing proceeds to step S602. On the other hand, when it has been determined otherwise, the processing of FIG. 6 is ended, and a reduction setting is not generated.

In step S602, the reduction setting proposal unit 315 specifies a device group that includes the serial No. of the image forming apparatus (131, 132) with use of the device group management unit 312. In step S603, with use of Table 3, the reduction setting proposal unit 315 obtains a list of serial Nos. and a reduction target of the device group specified in step S602. In step S604, the reduction setting proposal unit 315 obtains, from the actual performance data management unit 314, the actual performance values of the amounts of power consumption of the image forming apparatuses (131, 132) corresponding to the list of serial Nos. obtained in step S603. For example, if the reduction target is an N % reduction in a calendar quarter compared to the same period of a previous year, the actual performances of the current calendar quarter and the same calendar quarter of the previous year are obtained.

In step S605, the reduction setting proposal unit 315 compares the actual performances obtained in step S604 with the reduction target obtained in step S603 and determines whether the reduction target of an organization (tenant) can be achieved. That is to say, the reduction setting proposal unit 315 predicts whether the reduction target will be achieved if, for example, the image forming apparatus (131, 132) continues to be used at the same pace as the actual performances of the past. Then, when the reduction setting proposal unit 315 has determined that the reduction target of the organization can be achieved (an example of “in accordance with a determination result”), the processing of FIG. 6 is ended. In this case, a reduction setting is not generated.

On the other hand, when the reduction setting proposal unit 315 has not determined that the reduction target of the organization can be achieved, the processing proceeds to step S606. In step S606, the reduction setting proposal unit 315 (an example of a “generation unit”) generates a reduction setting (an example of a “second print setting”) that can reduce the amount of power compared to the print setting received from the image forming apparatus (131, 132) when printing is executed. Note that generation of a reduction setting is also referred to as conversion of a print setting. Then, the processing of FIG. 6 is ended.

The description of the flowchart of FIG. 5 now resumes. In step S504, the reduction setting proposal unit 315 transmits the print setting after the execution of the processing of the flowchart of FIG. 6 to the reduction setting inquiry unit 341 of the image forming apparatus (131, 132). That is to say, when the print setting has been converted, the reduction setting proposal unit 315 transmits the converted print setting; otherwise, the reduction setting proposal unit 315 transmits the print setting that was received from the image forming apparatus (131, 132) in step S502. Note that the image forming apparatus (131, 132) is an example of a “first information processing apparatus,” a “predetermined image forming apparatus,” and an “external apparatus.” Then, the reduction setting inquiry unit 341 of the image forming apparatus (131, 132) receives this print setting. Then, the reduction setting inquiry unit 341 returns the received print setting to the print setting unit 342.

In step S505, the print setting unit 342 (an example of a “second determination unit”) determines whether there is a difference between the print setting that was configured by the user in step S501 and the print setting that was returned from the reduction setting inquiry unit 341 in step S504. When the print setting unit 342 has determined that there is a difference, the processing proceeds to step S506; otherwise, the processing proceeds to step S508.

In step S506, the print setting unit 342 displays information related to the difference that was determined in step S505 on the operation panel 229. FIG. 4 exemplarily shows the operation panel 229 that displays a difference display dialog 401 that includes information related to such a difference. The difference display dialog 401 includes boxes (422, 423, 424) indicating the print setting that was configured by the user in step S501, and a box 421 indicating that the print setting displayed in the boxes (422, 423, 424) is a pre-change setting.

Also, the difference display dialog 401 includes boxes (432, 433, 434) that display the changed print setting, and a box 431 indicating that the print setting displayed in the boxes (432, 433, 434) is a post-change setting. Furthermore, the difference display dialog 401 includes an application button 441 for applying the post-change print setting, and a cancel button 442 for cancelling the application of the post-change print setting. Moreover, the difference display dialog 401 includes checkboxes (411, 412, 413) for selecting which of the post-change print settings to apply.

For example, the user checks at least one of the checkboxes (411, 412, 413) of the reduction setting and then presses the application button 441. Accordingly, in step S507, the print setting unit 342 transmits the print settings corresponding to the checkboxes that have been checked to the print control unit 346.

In step S508, the print control unit 346 reads the original document with use of the reader 232. Then, the read original data is transmitted to the raster controller 227 together with the print setting received from the print setting unit 342. The raster controller 227 generates image data with use of the received original data and print setting. Then, the print engine 228 executes printing by processing this image data.

In step S509, when printing has been completed, the print control unit 346 transmits job log information, including the print setting, to the data transmission unit 343. The data transmission unit 343 transmits the job log information as actual performance information to the actual performance data reception unit 316 of the target management service 121. Then, the actual performance data reception unit 316 of the target management service 121 receives this actual performance information. In step S510, the actual performance data reception unit 316 sends, to the image forming apparatus (131, 132), a response indicating that the actual performance information has been received.

Note that the first embodiment has been described in relation to a method of printing (copying) a document that has been read via the reader 232. However, the first embodiment is also applicable to a case where a document held in the storage apparatus 230 inside the image forming apparatus (131, 132) or the external memory 226 is printed.

Furthermore, the reduction setting proposal unit 315 may determine the actual performance of the past in a specific image forming apparatus (131, 132) that is attempting to execute printing, instead of the actual performances of the image forming apparatuses (131, 132) in the list of serial Nos., in step S605 That is to say, when it has been determined that this actual performance of the past is not an actual performance in which printing was executed under an environmentally-friendly print setting, a reduction setting may be aggressively proposed. This is because it is judged that a specific division that is mainly using the specific image forming apparatus (131, 132) in an organization is not making aggressive efforts toward a reduction in the amount of power, and ineffective printing has been performed on the specific image forming apparatus (131, 132).

### <One Aspect of Mechanisms and Advantageous Effects>

According to the first embodiment, when it is expected that a reduction target cannot be achieved in device group units based on the actual performance of printing in the past, a reduction setting is proposed. This makes it possible to make efforts toward a reduction target as an organization, rather than the image forming apparatus (131, 132) alone. Furthermore, according to the first embodiment, variations in the amounts of power consumption of respective users resulting from the use of the image forming apparatuses (131, 132) by the users, and the variations in the amounts of power consumption of the respective image forming apparatuses (131, 132), can be equalized in device group units. This makes it possible to suppress generation of an ineffective reduction setting to make efforts toward a reduction in the amounts of power consumption of the image forming apparatuses (131, 132) in organizational units. Moreover, according to the first embodiment, a reduction setting is proposed at the point where it is predicted that a reduction target cannot be achieved in group units. This makes it possible to promptly achieve a reduction in power consumption in group units.

### Second Embodiment

The first embodiment has been described in relation to processing for a print setting in a case where the image forming apparatus (131, 132) is the origin of print processing, such as a case of printing of a document read by the reader 232, or a document in a state where it is held in the storage apparatus 230 or the external memory 226. Meanwhile, there are cases where a print setting is configured on the client terminal 133 with use of the print application 302. Also, there are cases where an intended job is selected from among jobs that the print control unit 346 has displayed on the operation panel 229 on the image forming apparatus (131, 132), and accordingly, printing is performed under a print setting of the selected job. A second embodiment will be described in relation to processing for a reduction setting in these cases. Note that such a printing method is also referred to as forced hold printing. Also, the second embodiment will be described with a focus on the differences from the first embodiment.

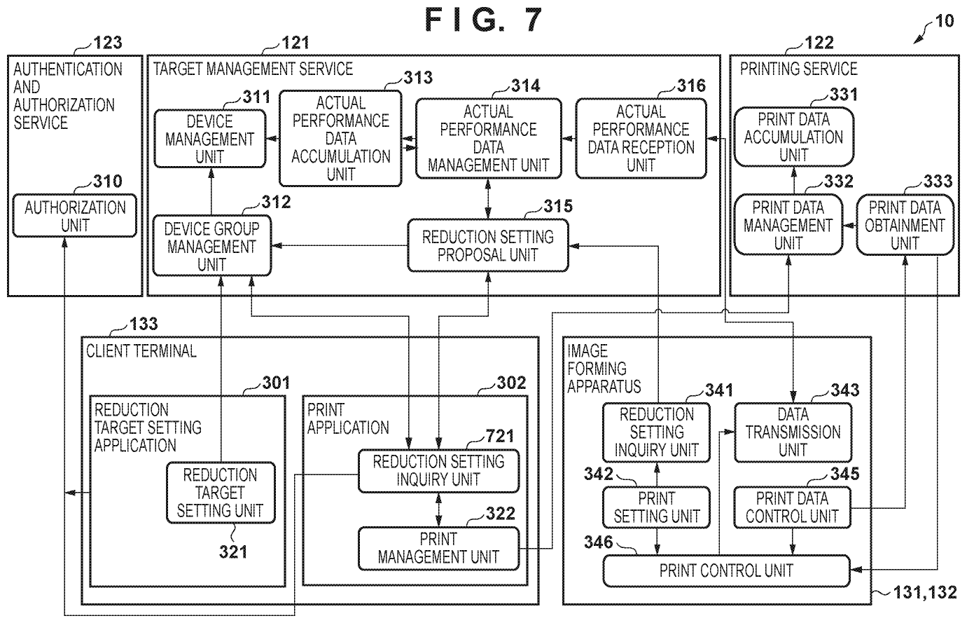

A software configuration of the print system 10 according to the second embodiment will be exemplarily shown in FIG. 7. In the second embodiment, the print application 302 of the client terminal 133 includes a reduction setting inquiry unit 721. The reduction setting inquiry unit 721 receives a print setting from the print management unit 322. Accordingly, the reduction setting inquiry unit 721 obtains a reduction setting from the device group management unit 312 or the reduction setting proposal unit 315 of the target management service 121 with use of an authorization token obtained from the authorization unit 310 of the authentication and authorization service 123.

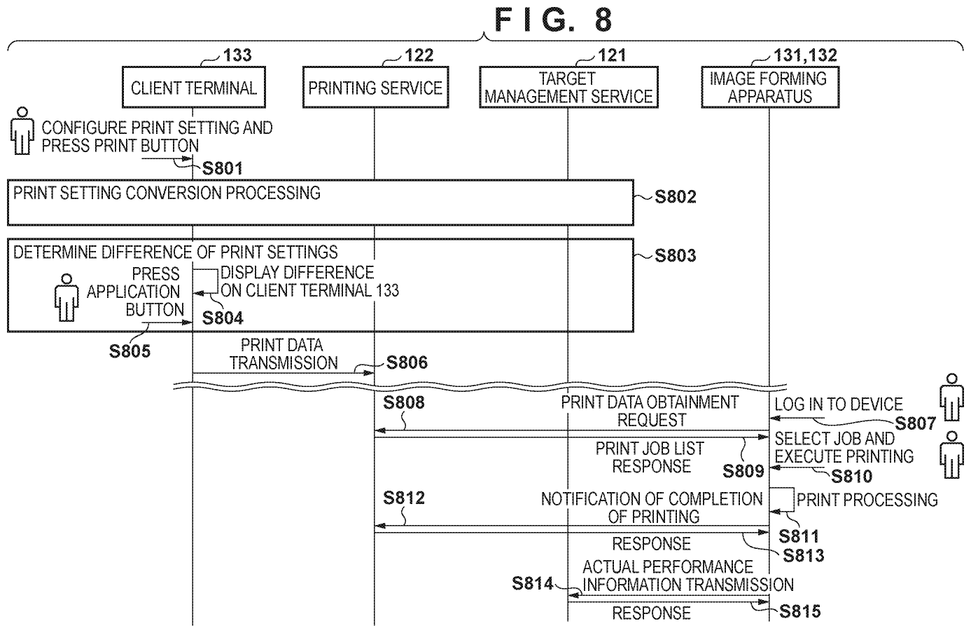

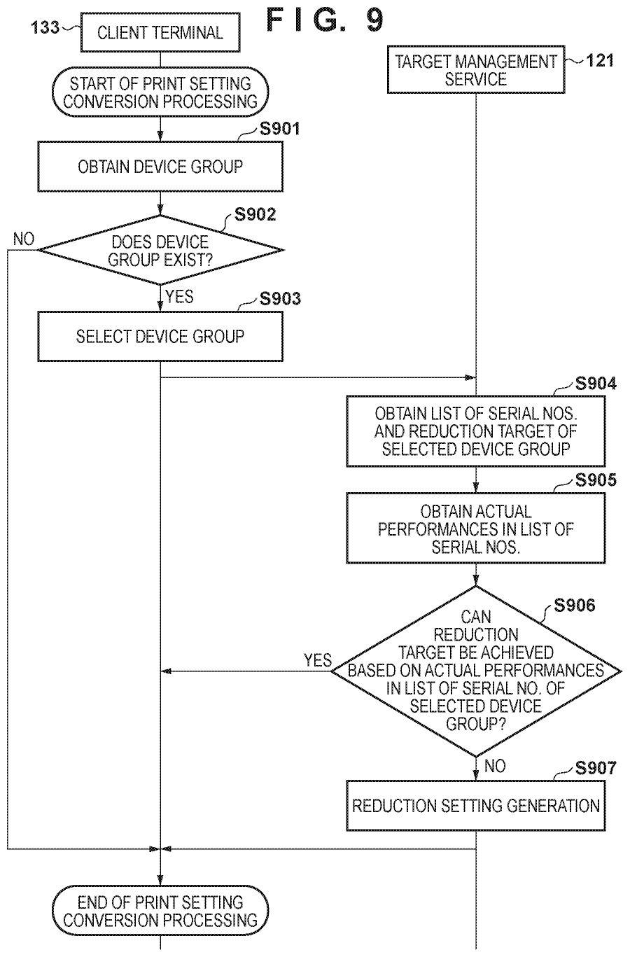

With reference to FIG. 8 and FIG. 9, a description is now given of a process for performing printing in the image forming apparatus (131, 132) with an application of a reduction setting in forced hold printing. Note that the processing illustrated in FIG. 8 and FIG. 9 is realized by the CPU of each apparatus constituting the print system 10 deploying programs stored in the ROM of each apparatus to the RAM and executing the programs.

In step S801 of FIG. 8, the print management unit 322 of the print application 302 on the client terminal 133 displays, on the input/output control unit 205, image data or a document in a state where it is held inside the client terminal 133. A user configures a print setting on a display screen, and presses a print button. Accordingly, the print management unit 322 accepts the print setting and the pressing operation on the print button. Then, the print management unit 322 transmits the accepted print setting to the reduction setting inquiry unit 721. Then, the reduction setting inquiry unit 721 receives the print setting.

In step S802, print setting conversion processing is executed through cooperation between the client terminal 133 and the target management service 121. A detailed flowchart of step S802 will be described with reference to FIG. 9. In step S901, the reduction setting inquiry unit 721 of the client terminal 133 obtains device group information associated with tenant IDs of an authorization token from the device group management unit 312 of the target management service 121.

In step S902, the reduction setting inquiry unit 721 determines whether device groups actually exist with use of the device group information obtained in step S901. Then, when the reduction setting inquiry unit 721 has determined that device groups exist, the processing proceeds to step S903. On the other hand, when it has been determined otherwise, the reduction setting inquiry unit 721 returns the received print setting as is to the print management unit 322, and the processing of FIG. 9 is ended.

In step S903, the print management unit 322 displays a list of device groups on the input/output control unit 205. Then, the user selects a device group by operating the input/output control unit 205. The reduction setting inquiry unit 721 transmits a group ID of the selected device group and the print setting that was received from the print management unit 322 in step S801 to the reduction setting proposal unit 315 of the target management service 121. Then, the reduction setting proposal unit 315 receives the group ID and the print setting.

In step S904, the reduction setting proposal unit 315 obtains a list of serial Nos. and a reduction target of the device group corresponding to the group ID selected by the user in step S903 by accessing the device group management unit 312. In step S905, the reduction setting proposal unit 315 obtains job logs corresponding to the obtained serial Nos. of the device group from the actual performance data accumulation unit 313 via the actual performance data management unit 314. In step S906, the reduction setting proposal unit 315 determines whether the reduction target of the device group can be achieved based on the list of actual performances of the obtained serial Nos. of the selected device group. Then, when the reduction setting proposal unit 315 has determined that the reduction target of the device group can be achieved, the reduction setting proposal unit 315 returns the print setting received from the reduction setting inquiry unit 721 of the client terminal 133 as is to the reduction setting inquiry unit 721. Then, the processing of FIG. 9 is ended. On the other hand, when it has been determined otherwise, the processing proceeds to step S907.

In step S907, the reduction setting proposal unit 315 converts the print setting into a print setting that can further reduce the amount of power consumption. Then, the converted print setting is transmitted to the reduction setting inquiry unit 721 of the client terminal 133. The print setting that has been converted by the reduction setting proposal unit 315 here is, for example, similar to the converted print setting according to the first embodiment. Alternatively, the print setting may be converted into a setting to “propose printing in an image forming apparatus (131, 132) that is a more environmentally-friendly model.” Then, the processing of FIG. 9 is ended.

The description of the flowchart of FIG. 8 now resumes. In step S803, the reduction setting inquiry unit 721 of the client terminal 133 returns, to the print management unit 322, the print setting returned from the reduction setting proposal unit 315 of the target management service 121. Then, the print management unit 322 determines whether there is a difference between the print setting that was configured by the user in step S801 and the print setting returned from the reduction setting inquiry unit 721. Then, when the print management unit 322 has determined that there is a difference, the processing proceeds to step S804; otherwise, the processing proceeds to step S806.

In step S804, the print management unit 322 displays the difference on a screen of the input/output control unit 205 of the client terminal 133 as shown in FIG. 4. Then, the user executes an operation similar to that of the first embodiment with respect to the screen. In step S805, the print management unit 322 accepts the user's pressing operation on the application button 441, thereby accepting the conversion of the print setting. In step S806, the print management unit 322 transmits print setting data, together with content data to be printed, to the print data management unit 332 of the printing service 122. Then, the print data management unit 332 receives the print setting data and the content data, and saves them into the print data accumulation unit 331.

In step S807, the print data control unit 345 of the image forming apparatus (131, 132) accepts a login operation of the user. In step S808, the print data control unit 345 makes a request for obtainment of a job list which is in a state where it is held in the print data accumulation unit 331, and which is associated with the user who has logged in, by accessing the print data obtainment unit 333 of the printing service 122. In step S809, in response to the obtainment request from the print data control unit 345 of the image forming apparatus (131, 132) in step S808, the print data obtainment unit 333 of the printing service 122 transmits a result of obtainment of a list of print jobs to the print control unit 346. Then, the print control unit 346 receives this result of obtainment and displays the same on the operation panel 229.

In step S810, the print control unit 346 accepts a user's selection operation on the list of print jobs displayed on the operation panel 229. In step S811, the print control unit 346 transmits the accepted print job to the raster controller 227. The raster controller 227 generates image data with use of content data and print setting data included in the received print job. Then, the print engine 228 executes printing by processing this image data.

In step S812, when print processing has been completed, the print control unit 346 provides the printing service 122 with a notification of completion of the print job via the print data control unit 345. In S813, the print control unit 346 receives a response to the notification of completion of the print job from the printing service 122 via the print data control unit 345. In step S814, the print control unit 346 transmits job log information including the print setting to the data transmission unit 343. The data transmission unit 343 transmits the job log information to the actual performance data reception unit 316 of the target management service 121. In step S815, the data transmission unit 343 receives a response to the transmission of the job log information from the actual performance data reception unit 316 of the target management service 121. Then, the processing is ended.

Note that the following processing may be executed when the reduction setting proposal unit 315 has converted the print setting into a setting to “propose printing in an image forming apparatus (131, 132) that is a more environmentally-friendly model” in step S907. That is to say, the reduction setting proposal unit 315 may embed information indicating a job that can be printed only on an image forming apparatus (131, 132) of a specific serial No. in a print job. Also, when the device management unit 311 has position information of the image forming apparatuses (131, 132), the reduction setting proposal unit 315 may propose an image forming apparatus (131, 132) close to the current location of the user with use of this position information. Then, when the foregoing processing has been executed, the print data control unit 345 may perform control in step S810 so that a print job cannot be obtained if the user has not operated the image forming apparatus (131, 132) corresponding to the proposed serial No. In this way, a reduction setting generated by the reduction setting proposal unit 315 may be intended for every device that belongs to the same group.

### <One Aspect of Mechanisms and Advantageous Effects>

According to the second embodiment, when a user uses a forced hold printing service, generation of an ineffective reduction setting can be suppressed to make efforts toward a reduction in the amounts of power consumption of the image forming apparatuses (131, 132) in organizational units.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-062549, filed Apr. 4, 2025, which is hereby incorporated by reference herein in its entirety.

What is claimed is:

1. An information processing system comprising:
one or more memory devices that store a set of instructions; and
one or more processors that execute the set of instructions to
obtain a first print setting of a predetermined image forming apparatus,
obtain a power consumption indicating an amount of power consumed by all image forming apparatuses included in a group to which the predetermined image forming apparatus belongs,
make a first determination about achievement of a power consumption reduction target for the group with use of the obtained power consumption, and
generate, in accordance with a result of the first determination, a second print setting that enables a reduction in power consumption compared to a case where printing is performed using the first print setting.

2. The information processing system according to claim 1, wherein
the one or more processors further execute the set of instructions to output the second print setting to a first information processing apparatus.

3. The information processing system according to claim 2, wherein
the first information processing apparatus includes the predetermined image forming apparatus.

4. The information processing system according to claim 2, wherein
the first information processing apparatus includes an image forming apparatus that belongs to the same group as the predetermined image forming apparatus.

5. The information processing system according to claim 2, wherein
the first information processing apparatus includes an information processing terminal that generates a print job for which a user executes printing using the predetermined image forming apparatus.

6. The information processing system according to claim 1, wherein
the one or more processors further execute the set of instructions to
accept an input for executing printing using the first print setting, and
output the first print setting in accordance with the accepted input.

7. The information processing system according to claim 1, wherein
the one or more processors further execute the set of instructions to
determine whether a difference exists between the first print setting and the second print setting, and
display the first print setting and the second print setting in a case of a determination that the difference exists.

8. The information processing system according to claim 1, wherein
the one or more processors further execute the set of instructions to
manage the power consumption of the image forming apparatuses, and
manage identifiers of the image forming apparatuses and the power consumption reduction target for the group to which the image forming apparatuses belong.

9. An information processing apparatus comprising:
one or more memory devices that store a set of instructions; and
one or more processors that execute the set of instructions to
obtain a first print setting of a predetermined image forming apparatus,
obtain a power consumption indicating an amount of power consumed by all image forming apparatuses included in a group to which the predetermined image forming apparatus belongs,
make a first determination about achievement of a power consumption reduction target for the group with use of the obtained power consumption, and
generate, in accordance with a result of the first determination, a second print setting that enables a reduction in power consumption compared to a case where printing is performed using the first print setting.

10. The information processing apparatus according to claim 9, wherein
the one or more processors further execute the set of instructions to output the second print setting to an external apparatus.

11. The information processing apparatus according to claim 10, wherein
the external apparatus includes the predetermined image forming apparatus.

12. The information processing apparatus according to claim 10, wherein
the external apparatus includes an image forming apparatus that belongs to the same group as the predetermined image forming apparatus.

13. The information processing apparatus according to claim 10, wherein
the external apparatus includes an information processing terminal that generates a print job for which a user executes printing using the predetermined image forming apparatus.

14. A control method for an information processing system, the control method comprising:
obtaining a first print setting of a predetermined image forming apparatus;
obtaining a power consumption indicating an amount of power consumed by all image forming apparatuses included in a group to which the predetermined image forming apparatus belongs;
making a first determination about achievement of a power consumption reduction target for the group with use of the obtained power consumption; and
generating, in accordance with a result of the first determination, a second print setting that enables a reduction in power consumption compared to a case where printing is performed using the first print setting.

15. A non-transitory computer-readable storage medium storing a program for causing a computer to execute each process of a control method for an information processing system, the control method comprising:
obtaining a first print setting of a predetermined image forming apparatus;
obtaining a power consumption indicating an amount of power consumed by all image forming apparatuses included in a group to which the predetermined image forming apparatus belongs;
making a first determination about achievement of a power consumption reduction target for the group with use of the obtained power consumption; and
generating, in accordance with a result of the first determination, a second print setting that enables a reduction in power consumption compared to a case where printing is performed using the first print setting.
